(19) United States
(12) Patent Application Publication
(10) Pub. No.: US 2021/0383687 A1
(43) Pub. Date: Dec. 9, 2021

(54) SYSTEM AND METHOD FOR PREDICTING A ROAD OBJECT ASSOCIATED WITH A ROAD ZONE

(71) Applicant: HERE Global B.V., Eindhoven (NL)

(72) Inventors: Leon STENNETH, Chicago, IL (US); Adekunle AFOLABI, Aurora, IL (US); Zhenhua ZHANG, Chicago, IL (US)

(21) Appl. No.: 17/094,493

(22) Filed: Nov. 10, 2020

Related U.S. Application Data
(60) Provisional application No. 63/034,216, filed on Jun. 3, 2020.

(51) Int. Cl. G08G 1/01; G06N 20/00; G08G 1/0967; G08G 1/09

(52) U.S. Cl. CPC G08G 1/0141; G06N 20/00; G08G 1/093; G08G 1/096716; G08G 1/0116

(57) ABSTRACT

A method and a system are disclosed for predicting that a road object is in a road zone or not. The method may include receiving at least one road object observation associated with the road object; extracting at least one feature associated with the road object or surroundings thereof based on the received at least one road object observation; and predicting, using a trained machine learning model, that the road object is in the road zone or not based on the extracted at least one feature, wherein the machine learning model is trained based on a training data set comprising a combination of at least one training feature and a ground truth label data, wherein the ground truth label data comprises at least one of a road zone data and a non-road zone data.

### RELATED APPLICATION

This application claims priority from U.S. Provisional Application Ser. No. 63/034,216, entitled “SYSTEM AND METHOD FOR PREDICTING A ROAD OBJECT ASSOCIATED WITH A ROAD ZONE,” filed on Jun. 3, 2020, the contents of which are hereby incorporated herein in their entirety by this reference.

### TECHNOLOGICAL FIELD

The present disclosure generally relates to routing and navigation systems, and more particularly relates to predicting whether a road object is in a road zone or not for routing and navigation applications.

### BACKGROUND

Currently, various navigation applications are available for vehicle navigation. These navigation applications generally use mapping applications, such as those offered by third party service providers like websites, mobile app providers and the like, to request navigation related data. The navigation related data may include data about navigation routes, signs posted on these routes, sign information and the like, which may be obtained by using various navigation devices. Navigation devices based on Global Positioning System (GPS) technology have become common, and these devices are capable of determining the location of a device for navigating the vehicles on a requested route. However, the navigation related data provided by the navigation devices may not be accurate, when the navigation related data is associated with road zones such as an accident zone, a road work zones and the like, as these zones vary with time.

### BRIEF SUMMARY OF SOME EXAMPLE EMBODIMENTS

In some navigation applications, mapping applications may rely on map data obtained from a map database. The map data may include road objects posted on the route. Sometimes these road objects may be road signs, such as speed signs, that provide information regarding a speed limit value to be followed on the route. Generally, an association of the map data with the road zones such as an accident zone, a road works zone and the like may not be up-to-date. In other words, the road sign posted on the route may be updated in the map database, but the association of the road sign posted on the route with the road zone may not be up-to-date. For example, a road sign displaying a speed limit of 80 km/h may be posted at a location, where a construction work may have started. As a result, the area around or surroundings of the road sign may now be associated with a road zone. The road sign value may still be correctly updated in the map database, but information regarding the presence of the road zone may not be correctly updated in the map database, as the map database may not be generally updated very frequently. As a result a vehicle travelling on a route on which the road sign is posted may follow the speed limit value of 80 km/h based on data provided by the map, though actual requirement of speed limit may be much lesser. In case such a vehicle is an autonomous vehicle, following incorrect speed limit in this manner may become hazardous. As a result, the vehicle performing navigation functions using such an outdated map data may lead to unwanted situations such as road accidents, traffic congestions, increased travel time, wastage of vehicle mile and the like. Accordingly, the map data related to the road object association with the road zone should be up-to-date in real time for various navigation applications such as in autonomous driving applications. To that end, various embodiments provide for predicting presence data of a road zone associated with a road object to accurately provide the map data such that the unwanted situations such as road accidents, traffic congestions, and increased travel time may be avoided. Various embodiments are provided for receiving at least one road object observation associated with the road object. As used herein, the road object observation is an observation made by one or more sensors of the vehicle. For instance, the vehicle may be equipped with one or more sensors for determining a location associated with the road object and determining the road object value associated with the road with the road object. To that end, the road object observation may include the location and the road object value associated with the road object. Additionally, in some embodiments, the road object observation may include a timestamp indicating a time instance at which the road object observation was made. The road object may comprise a speed limit sign, a construction work sign, an accident site object, a road divider, a construction object, an accident site sign, a road flare, a traffic cone, a guardrail or the like.

Various embodiments provide for extracting at least one feature associated with the road object or road thereof, based on the received at least one road object observation. In some example embodiments, the at least one feature may be extracted using at least one of map data, third party feeds, and sensor data. According to some embodiments, the at least one feature may be extracted for the received at least one road object observation. To that end, the extracted at least one feature may be a spatiotemporal feature. The at least one feature may comprise at least one of a third party traffic incident feed feature, a road object value feature, a lane marking color feature, a real time traffic feature, a traffic flow feature, a traffic pattern feature, a number of lanes feature, a road work sign recognition event feature, a lane chicane feature, or a combination thereof.

Various embodiments provide for predicting, using a trained machine learning model, the presence data of a road zone associated with the road object, based on the extracted at least one feature. The road zone may comprise one or more of an accident zone, a road work zone, a vehicle-break-down zone, and the like. The machine learning model may be a supervised machine learning model. The machine learning model may comprise a random forest algorithm, a decision tree algorithm, a neural network algorithm and the like. According to some embodiments, the machine learning model may be trained based on a training data set. The training data set may comprise a combination of at least one training feature for each of a plurality of road objects and ground truth label data for each of a plurality of road objects. The ground truth label data may comprise at least one of a road zone data and a non-road zone data. In some example embodiments, the trained machine learning model may be executed for the extracted at least one feature to predict the presence data of the road zone associated with the road object. In some example embodiments, the prediction results may be outputted as a presence indicator value. The presence indicator value may comprise at least one of a road zone indication and a non-road zone indication. Various embodiments provide for updating the map data to indicate the presence of the road object in the road zone based on the prediction results. Various embodiments provide for providing a confidence score for the prediction results. Various embodiments provide for generating one or more control signals for controlling the vehicle based on the prediction results. To that end, the vehicle may be automatically controlled by the generated control signals or a user of the vehicle may manually control the vehicle by using the updated map data, when the road object is associated with the road zone. Therefore, the unwanted situations such as road accidents, traffic congestions, increased travel time, wastage of vehicle mile and the like may be avoided.

A method and a system are provided in accordance with an example embodiment described herein for predicting presence data of a road zone associated with a road object.

In one aspect, a method for predicting that a road object is in a road zone or not is disclosed. The method may comprise receiving at least one road object observation associated with the road object; extracting at least one feature associated with the road object or surroundings thereof based on the received at least one road object observation; and predicting, using a trained machine learning model, that the road object is in the road zone or not based on the extracted at least one feature, wherein the machine learning model is trained based on a training data set comprising a combination of at least one training feature and a ground truth label data, wherein the ground truth label data comprises at least one of a road zone data and a non-road zone data.

According to some embodiments, wherein predicting that the road object is in the road zone or not may further comprise outputting a presence indicator value from the trained machine learning model, wherein the presence indicator value may comprise at least one of a road zone indication and a non-road zone indication.

According to some embodiments, wherein the at least one feature may comprise at least one of a third party traffic incident feed feature, a road object value feature, a lane marking color feature, a real time traffic feature, a traffic flow feature, a traffic pattern feature, a number of lanes feature, a road work sign recognition event feature, a lane chicane feature, or a combination thereof.

According to some embodiments, the method may further comprise updating a map database based on the prediction.

According to some embodiments, wherein the at least one feature may be a spatiotemporal feature.

According to some embodiments, wherein the road zone may comprise at least one of an accident zone and a road work zone.

According to some embodiments, wherein the road object may comprise a speed limit sign, a construction work sign, an accident site object, a road divider, a construction object, an accident site sign, or a road flare.

According to some embodiments, wherein the at least one road object observation may comprise at least one of a location associated with the road object, a timestamp associated with the road object, or a combination thereof.

According to some embodiments, the method may further comprise determining a confidence value for the prediction; comparing the confidence value with a threshold confidence value; and accepting the prediction in response to determining that the confidence value is greater than the threshold confidence value.

According to some embodiments, the method may further comprise determining a confidence value for the prediction; comparing the confidence value with a threshold confidence value; and transmitting a request for a manual examination of the road object, in response to determining that the confidence value is lesser than the threshold confidence value.

In another aspect a system for predicting presence data of a road zone associated with a road object is disclosed The system may comprise a memory configured to store computer-executable instructions; and one or more processors configured to execute the instructions to: receive at least one road object observation associated with the road object; extract at least one feature associated with the road object or a road thereof, based on the received at least one road object observation; and predict, using a trained machine learning model, presence data of the road zone associated with the road object based on the extracted at least one feature, wherein the machine learning model is trained based on a training data set comprising a combination of at least one training feature and a ground truth label data, wherein the ground truth label data comprises at least one of a road zone data or a non-road zone data.

According to some embodiments, wherein to predict the presence data of the road zone associated with the road object, the one or more processors may be further configured to execute the instructions to output a presence indicator value from the trained machine learning model, wherein the presence indicator value comprises at least one of a road zone indication and a non-road zone indication.

According to some embodiments, wherein the at least one feature may comprise at least one of a third party traffic incident feed feature, a road object value feature, a lane marking color feature, a real time traffic feature, a traffic flow feature, a traffic pattern feature, a number of lanes feature, a road work sign recognition event feature, a lane chicane feature, or a combination thereof.

According to some embodiments, wherein the one or more processors may be further configured to execute the instructions to update a map database based on the prediction.

According to some embodiments, wherein the at least one feature may be spatiotemporal feature.

According to some embodiments, wherein the road zone may comprise one or more of an accident zone and a road work zone.

According to some embodiments, wherein the road object may comprise a speed limit sign, a construction work sign, an accident site object, a road divider, a construction object, an accident site sign, or a road flare.

According to some embodiments, wherein the one or more processors may be further configured to execute the instructions to: determine a confidence value for the predicted presence data of the road zone; compare the confidence value with a threshold confidence value; and accept the predicted presence data of the road zone in response to determining that the confidence value is greater than the threshold confidence value.

According to some embodiments, wherein the one or more processors may be further configured to execute the instructions to: determine a confidence value for the predicted presence data of the road zone; compare the confidence value with a threshold confidence value; and transmit a request for a manual examination of the road object, in response to determining that the confidence value is lesser than the threshold confidence value.

In yet another aspect, a computer program product comprising a non-transitory computer readable medium having stored thereon computer executable instruction which when executed by one or more processors, cause the one or more processors to carry out operations for training a machine learning model, the operations comprising: obtaining a plurality of road object observations; extracting at least one training feature for each of the plurality of road object observations; determining a ground truth label data for each of the plurality of road object observations, wherein the ground truth label data comprises at least one of a road zone data or a non-road zone data; and training the machine learning model, based on a training data set associated with each of the plurality of road object observations, wherein the training data set comprises a combination of at least the extracted at least one training feature and the determined ground truth label data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram showing an example architecture of a system for predicting presence data of a road zone associated with a road object, in accordance with one or more example embodiments;

FIG. 2 illustrates a block diagram of a system for predicting the presence data of the road zone associated with the road object, in accordance with one or more example embodiments;

FIG. 3 illustrates a schematic diagram of an exemplary working environment of the system exemplarily illustrated in FIG. 2, in accordance with one or more example embodiments;

FIGS. 4A-4B illustrate an exemplary training data set and training phase of a machine learning model, in accordance with one or more example embodiments;

FIG. 5 illustrates a schematic diagram of an exemplary working environment of the system exemplarily illustrated in FIG. 2, in accordance with one or more example embodiments; and

FIG. 6 illustrates a flowchart depicting a method for training a machine learning model, in accordance with one or more example embodiments.

FIGS. 7A-7B illustrate a flowchart depicting a method for predicting that the road object is in the road zone or not, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A method and a system are provided for predicting presence data of a road zone associated with a road object. Various embodiments are provided for receiving at least one road object observation associated with the road object. In various embodiments, the road object may comprise a speed limit sign, a construction work sign, an accident site object, a road divider, a construction object, an accident site sign, a road flare, a traffic cone, a guardrail or the like. Various embodiments provide for extracting at least one feature associated with the road object or road thereof, based on the received at least one road object observation. In some example embodiments, the at least one feature may be extracted using at least one of map data, third party feeds, and sensor data. According to some embodiments, the at least one feature may be extracted in association with a timestamp for the received at least one road object observation. To that end, the extracted at least one feature may be a spatiotemporal feature. That is to say, the at least one feature may have different values based on variation in time or geographic constraints. For example, for different times of day, and for different regions or countries or cities, the feature may have different values and different relevance. In some embodiments, a relevancy score may be associated with the feature, to provide a weightage to the feature when using a combination of such features, as will be described in various embodiments disclosed herein. The at least one feature may comprise at least one of a third party traffic incident feed feature, a road object value feature, a lane marking color feature, a real time traffic feature, a traffic flow feature, a traffic pattern feature, a number of lanes feature, a road work sign recognition event feature, a lane chicane feature, or a combination thereof.

Various embodiments provide for predicting, using a trained machine learning model, the presence data of a road zone associated with the road object, based on the extracted at least one feature. The road zone may comprise one or more of an accident zone, a road work zone, a vehicle-break-down zone, and the like. The machine learning model may be a supervised machine learning model. The machine learning model may comprise a random forest algorithm, a decision tree algorithm, a neural network algorithm and the like. According to some embodiments, the machine learning model may be trained based on a training data set. The training data set may comprise a combination of at least one training feature and a ground truth label data. The ground truth label data may comprise at least one of a road zone data and a non-road zone data. In some example embodiments, the trained machine learning model may be executed for the extracted at least one feature to predict the presence data of the road zone associated with the road object. In some example embodiments, the prediction results may be outputted as a presence indicator value. The presence indicator value may comprise at least one of a road zone indication and a non-road zone indication. Various embodiments provide for updating the map data to indicate the presence of the road object in the road zone based on the prediction results. Various embodiments provide for providing a confidence score for the prediction results. Various embodiments provide for generating one or more control signals for controlling the vehicle based on the prediction results. To that end, the vehicle may be automatically controlled by the generated control signals or a user of the vehicle may manually control the vehicle by using the updated map data, when the road zone is associated with the road object. Therefore, the unwanted situations such as road accidents, traffic congestions, increased travel time, wastage of vehicle mile and the like may be avoided. Further, the updated map data may be used to perform one or more navigation functions. Some non-limiting examples of the navigation functions may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

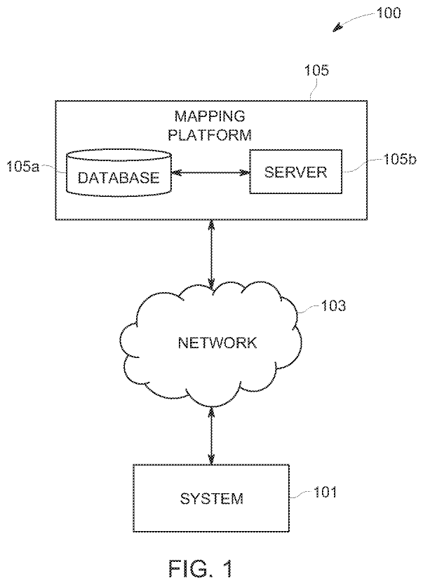

FIG. 1 illustrates a block diagram 100 showing example architecture of a system for predicting presence data of a road zone associated with a road object, in accordance with one or more example embodiments. As illustrated in FIG. 1, the block diagram 100 may comprise a system 101, a mapping platform 105, and a network 103. The mapping platform 105 may further comprise a database 105a and a server 105b. In various embodiments, the system 101 may be an (Original Equipment Manufacturer) OEM cloud. To that end, the system 101 may be a server (for instance, a backend server, a remotely located server, or the like), group of servers, distributed computing system, and/or other computing system. In some embodiments, the system 101 may be onboard a vehicle, such as the system 101 may be a navigation system installed in the vehicle. In various embodiments, the vehicle may be an autonomous vehicle, a semiautonomous vehicle, or a manual vehicle. In an embodiment, the system 101 may be the server 105b of the mapping platform 105 and therefore may be co-located with or within the mapping platform 105. The system 101 may be communicatively coupled with the mapping platform 105 over the network 103.

The network 103 may be wired, wireless, or any combination of wired and wireless communication networks, such as cellular, Wi-Fi, internet, local area networks, or the like. In some embodiments, the network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The system 101 may communicate with the mapping platform 105, via the network 103, where the mapping platform 105 may comprise the map database 105a for storing map data, and the processing server 105b for carrying out the processing functions associated with the mapping platform 105. The map database 105a may store node data, road segment data or link data, point of interest (POI) data, posted signs related data, such as road sign data or the like. The map database 105a may also include cartographic data and/or routing data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road/link data and the node data may represent a road network, such as used by vehicles, for example, cars, trucks, buses, motorcycles, and/or other entities.

Optionally, the map database 105a may contain path segment and node data records or other data that may represent pedestrian paths or areas in addition to or instead of the vehicle road record data, for example. The road/link segments and nodes may be associated with attributes, such as geographic coordinates, street names, address ranges, lane level speed profile (historically derived speed limits for a lane), lane level maneuver pattern (lane change patterns at intersections), and other navigation related attributes, as well as POIs, such as fueling stations, hotels, restaurants, museums, stadiums, offices, auto repair shops, buildings, stores, parks, etc. The map database 105a may include data about the POIs and their respective locations in the POI records. The map database 105a may additionally include data about places, such as cities, towns, or other communities, and other geographic features such as bodies of water, mountain ranges, etc. Such place or feature data may be part of the POI data or may be associated with POIs or POI data records (such as a data point used for displaying or representing a position of a city). In addition, the map database 105a may include event data (e.g., traffic incidents, construction activities, scheduled events, unscheduled events, etc.) associated with the POI data records or other records of the map database 105a. The map database 105a may additionally include data related to road signs. The map database may be communicatively coupled to the processing server 105b.

The processing server 105b may comprise processing means and communication means. For example, the processing means may comprise one or more processors configured to process requests received from the system 101. The processing means may fetch map data from the map database 105a and transmit the same to the system 101 in a format suitable for use by the system 101. In some example embodiments, as disclosed in conjunction with the various embodiments disclosed herein, the system 101 may be used to predict presence data of the road zone associated with the road object.

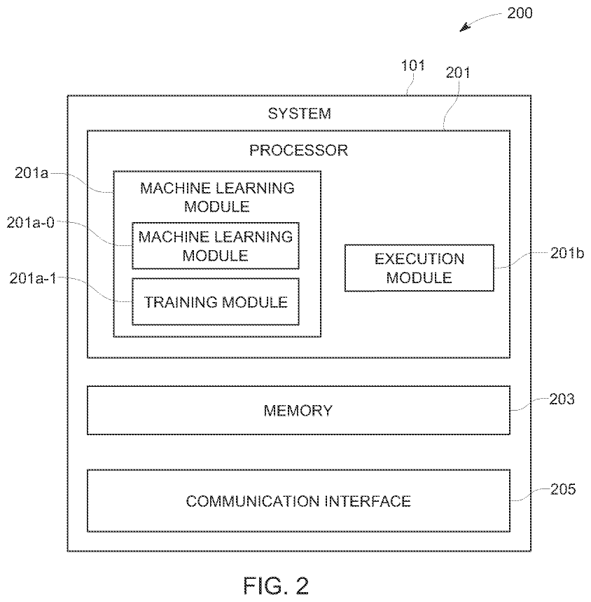

FIG. 2 illustrates a block diagram 200 of the system 101 for predicting presence data of a road zone associated with a road object, in accordance with one or more example embodiments of the present invention. The system 101 may include a processing means such as at least one processor 201, storage means such as a memory 203, and a communication means such as at least one communication interface 205. Further, the system 101 may comprise a machine learning module 201a and an execution module 201b. The machine learning module 201a may comprise a machine learning model 201a-0 and a training module 201a-1. In various embodiments, the machine learning model 201a-0 may comprise a classification algorithm. According to some embodiments, the classification algorithm may include at least one of a random forest algorithm, a decision tree algorithm, a neural network (NN) algorithm, and the like. In various embodiments, the training module 201a-1 may be configured for training the machine learning model 201a-0 for predicting the presence data of the road zone associated with the road object. In various embodiments, the execution module 201b may be configured to execute the trained machine learning model for predicting the presence data of the road zone associated with the road object. According to some embodiments, the machine learning module 201a and the execution module 201b may be embodied in the processor 201. The processor 201 may retrieve computer program code instructions that may be stored in the memory 203 for execution of computer program code instructions, which may be configured for training the machine learning model 201a-0. Further, in some embodiments, when the machine learning model 201a-0 is trained, it may be used as a trained machine learning model 201a-0 for predicting presence data of the road zone associated with the road object.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally or alternatively, the processor 201 may include one or more processors configured in tandem via the bus to enable independent execution of instructions, pipelining and/or multithreading.

Additionally or alternatively, the processor 201 may include one or more processors capable of processing large volumes of workloads and operations to provide support for big data analysis. In an example embodiment, the processor 201 may be in communication with a memory 203 via a bus for passing information among components of structure 100. The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the system 101 to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

In some embodiments, the processor 201 may be configured to provide Internet-of-Things (IoT) related capabilities to users of the system 101, where the users may be a traveler, a rider, a pedestrian, a driver of the vehicle and the like. In some embodiments, the users may be or correspond to an autonomous or semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101. For example, the communication interface may comprise I/O interface which may be in the form of a GUI, a touch interface, a voice enabled interface, a keypad and the like. For example, the communication interface may be a touch enabled interface of a navigation device installed in a vehicle, which may also display various navigation related data to the user of the vehicle. Such navigation related data may include information about upcoming conditions on a route, route display, alerts about vehicle speed, user assistance while driving and the like.

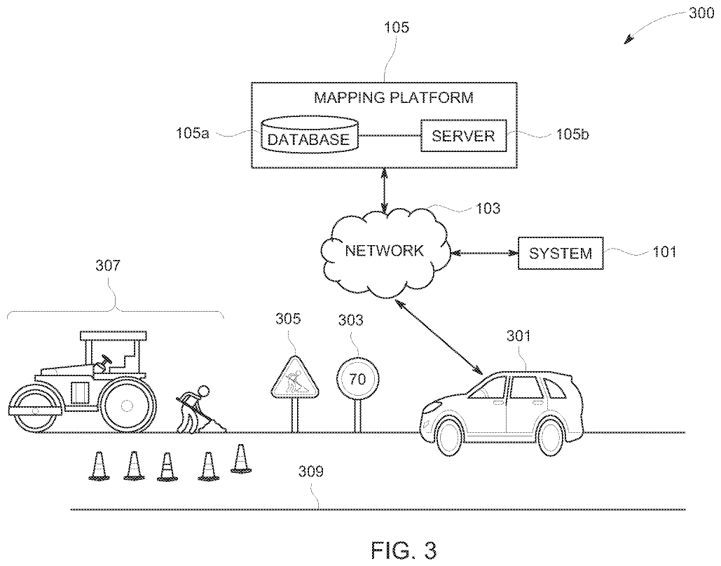

FIG. 3 illustrates a schematic diagram 300 of an exemplary working environment of the system 101 exemplarily illustrated in FIG. 2, in accordance with one or more example embodiments. As illustrated in FIG. 3, the schematic diagram 300 may include the system 101, the network 103, the mapping platform 105, a vehicle 301, a road object 303, a road work sign 305, a road zone 307, and a road 309. A user such as a driver, a traveler, or the like based on his/her requirements may travel along the road 309 through the vehicle 301. The vehicle 301 may be an autonomous vehicle, a semiautonomous vehicle, or a manual vehicle. In various embodiments, the vehicle 301 may be equipped with sensors for generating or collecting vehicular sensor data (also referred to as sensor data), related geographic/map data, etc. According to some embodiments, the sensors may comprise image capture sensors configured to capture images of the road object 303 along the road 309. Further, the sensors may comprise one or more position sensors configured to determine a location of the road object 303. As used herein, the road object 303 may correspond to a speed limit sign. Here, the road object 303 being the speed limit sign is considered for illustration purpose. In various embodiments, the speed limit sign may be a static speed sign, a mechanical variable speed sign, a variable speed sign, or a conditional static speed sign. In various embodiments, the road object 303 may comprise a speed limit sign, a directional guidance sign, a signboard indicating route deviation, a signboard indicating some ongoing work along the road 309 (for instance, the road work sign 305), a road divider, a construction object, a road flare and the like.

Once, when the sensors of the vehicle 301 reports a location associated with the road object 303 (for instance, the location of the speed limit sign) and a road object value associated with the road object 303 (for instance, the speed sign value of the speed limit sign), the system 101 may be triggered to predict presence data of the road zone 307 associated with the reported road object 303. In other words, the system 101 may be triggered to predict whether the reported road object 303 (for instance, the reported speed limit sign) is in the road zone 307 or not, when the system 101 receives the location associated with the road object 303 and the road object value associated with the road object 303. Hereinafter, ‘the location and the road object value’ and ‘the road object observation’ may be interchangeably used to mean the same. In various embodiments, the system 101 may be a remotely located server, a backend server, or the like for updating the map data of the database 105a and/or a local map cache of the vehicle 301 based on the prediction. In some embodiments, the system 101 may be the server 105b associated with the mapping platform 105. In some embodiments, the system 101 may be onboard the vehicle 301 for updating the map data of the database 105a and/or the local map cache of the vehicle 301 based on the prediction. In various embodiments, the road zone 307 may comprise an accident zone, a road work zone, a vehicle-brake-down zone, and the like. According to some embodiments, the road zone 307 may comprise an area around the road object 303, such as an area lying within a threshold distance around the road object 303. Here for the illustration purpose, a road event (for instance, a road work) is considered to be the road zone 307 which covers an entire area within a threshold distance around the road object 303. To that end, the road zone 307 may correspond to a road work zone 307. The system 101 for predicting presence data of the road work zone 307 associated with the road object 303 is as detailed below.

In various embodiments, the system 101 may be configured to receive, from the sensors of the vehicle 301, at least one road object observation associated with the road object 303. In various embodiments, the road object observation may comprise a location associated with the road object 303 and a road object value associated with the road object 303. Further, in some embodiments, the road object observation may comprise a timestamp indicating a time instance at which the road object observation was made. Additionally, in some embodiments, the system 101 may be configured to receive, from the sensors of the vehicle 301, sensor data associated with the road object 303, sensor data associated with the road 309, or sensor data associated with surroundings thereof. For instance, the system 101 may receive sensor data associated with the road object 303 and the sensor data associated an area (for example, a threshold distance from the road object 303) around the road object 303.

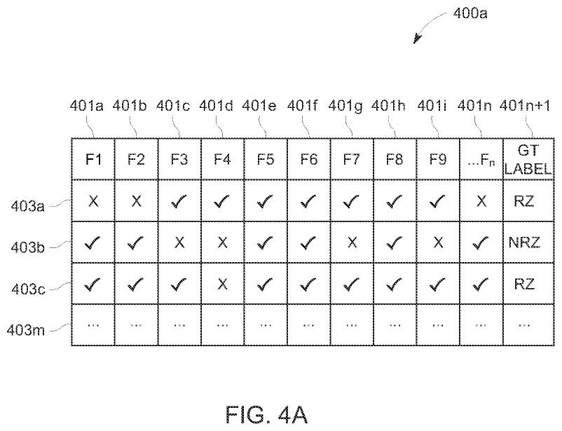

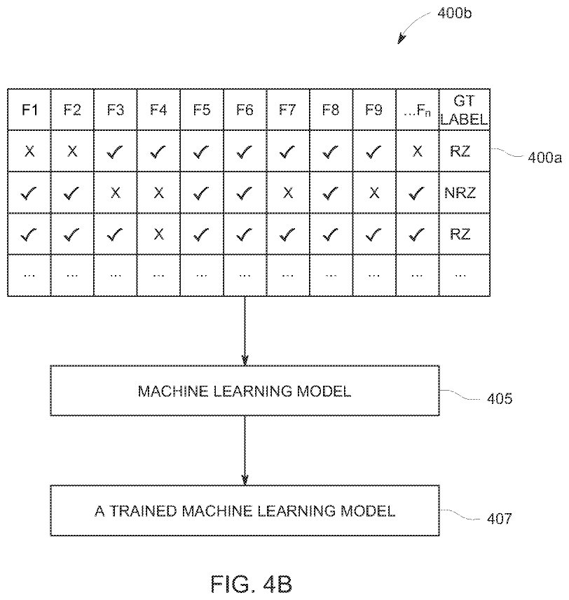

In various embodiments, the system 101 may be configured to extract at least one feature associated with the road object 303, the road 309, or the surrounding thereof based on the received at least one road object observation. In some embodiments, the system 101 may extract, using at least one of the received sensor data, the map data of the database 105a, and third party feed data, the at least one feature for the received at least one road object observation. For instance, the system 101 may extract the at least feature in association with the timestamp (i.e. the time instance at which the road object was made) for the received location of the road object 303 using the at least one of the received sensor data, the map data of the database 105a, and the third party feed data. To that end, the at least one feature may be a spatiotemporal feature. In various embodiments, the at least one feature may comprise at least one of a third party traffic incident feed feature, a road object value feature, a lane marking color feature, a real time traffic feature, a traffic flow feature, a traffic pattern feature, a number of lanes feature, a road work sign recognition event feature, a lane chicane feature, or a combination thereof. Further, the extraction of the at least one feature associated with the road object 303, the road 309, or the surrounding thereof is discussed in conjunction with FIGS. 4A and 4B and is detailed below.

In some embodiments, the system 101 may extract the third party incident feed feature (also referred as feature F1), based on the received road object observation and the third party feed data. Hereinafter, the ‘third party incident feed feature’ and the ‘feature F1’ may be interchangeably used to mean the same. In various embodiments, the third party feed data may be road work event data (for instance, a location of the road zone 307) reported by third parties, such as government officials, map content providers, and the like. In some embodiments, the system 101 may determine an on-route distance between the location of the road object 303 and the location of the road zone 307 for extracting the third party incident feed feature. According to some example embodiments, the on-route distance between the location of the road object 303 and the location of the road zone 307 being less than a pre-defined distance may indicate that the road object 303 is in the road work zone 307.

In some embodiments, the system 101 may extract the road object value feature (also referred as feature F2) based on the received road object observation and the map data of the database 105a. Hereinafter, the ‘road object value feature’ and the ‘feature F2’ may be interchangeably used to mean the same. In various embodiments, the system 101 may determine, using the map data of the database 105a, a speed limit value of a lane of the road 309 on which the vehicle is travelling and compare the determined speed limit value with the speed value reported at or in the vicinity of the location of the received road object observation, for extracting the road object value feature. According to some embodiments, the speed limit value reported in the received road object observation being less than the determined speed limit value may indicate that the road object 303 is in the road work zone 307.

In some embodiments, the system 101 may extract the lane marking color feature (also referred as feature F3) based on the received road object observation and the sensor data associated with the road 309. Hereinafter, the ‘lane marking color feature’ and the ‘feature F3’ may be interchangeably used to mean the same. In various embodiments, the system 101 may determine a lane marking color associated with the road 309 for the received road object observation to extract the lane marking color feature. To that end, the sensor data associated with the road 309 may comprise a lane marking color associated with the road 309. According to some embodiments, the lane marking color associated with the road 309 being yellow may indicate that the road object 303 is in the road work zone 307. However, the lane marking color indicating that the road object 303 is in the road work zone 307 may vary based on geographical regions (for instance, country-based variations).

In some embodiments, the system 101 may extract the real time traffic feature (also referred as feature F4) based on the received road object observation and the map data of the database 105a. Hereinafter, the ‘real time traffic feature’ and the ‘feature F4’ may be interchangeably used to mean the same. In various embodiments, the system 101 may determine the real time traffic on the lane of the road 309 or the road 309 on which the vehicle 301 is travelling for extracting the real time traffic feature. For instance, the system 101 may determine the real time traffic on the lane or the road 309 as a number for the given timestamp and the given location of the road object 303 from the database 105a. According to some embodiments, the real time traffic being significantly different than pre-defined real time traffic may indicate that the road object 303 is in the road work zone 307.

In some embodiments, the system 101 may extract the traffic flow feature (also referred as feature F5) based on the received road object observation and the map data of the database 105a. Hereinafter, the ‘traffic flow feature’ and the ‘feature F5’ may be interchangeably used to mean the same. In various embodiments, the system 101 may determine a traffic flow category of the lane of the road 309 or the road 309 on which the vehicle 301 is travelling for extracting the traffic flow feature. For instance, the system 101 may determine the traffic flow category as at least one of red, yellow, and green for the given timestamp and the given location of the road object 303 from the database 105a. According to some embodiments, the traffic flow category being red or yellow during non-peak travel time may indicate that the road object 303 is in the road work zone 307.

In some embodiments, the system 101 may extract the traffic pattern feature (also referred as feature F6) based on the received road object observation and the map data of the database 105a. Hereinafter, the ‘traffic pattern feature’ and the ‘feature F6’ may be interchangeably used to mean the same. In various embodiments, the system 101 may determine, using the database 105a, a historic traffic pattern (TP) for the given location of the road object 303; determine, using the database 105a, a real time traffic pattern (RT) for the given time stamp and the given location of the road object 303; and compute a difference between the historic traffic pattern (TP) and the real time traffic pattern (RT), for extracting the traffic pattern feature. In some embodiments, the system 101 may determine the historic traffic pattern (TP) for the given location from a historic speed data associated with the given location. In some example embodiments, the historic speed data may be past three years historic speed data. In some embodiments, the system 101 may determine the real time traffic pattern (RT) for the given timestamp and the given location from a recent traffic speed data of say recent fifteen minutes (for instance, real time probes of recent fifteen minutes). In some embodiments, the system 101 may compute

$$\frac{\vert TP - RT \vert}{TP}$$

for determining the difference between the historic traffic pattern (TP) and the real time traffic pattern (RT). According to some embodiments, the difference between the historic traffic pattern (TP) and the real time traffic pattern (RT) being varying significantly from a pre-defined difference may indicate that the road object 303 is in the road work zone 307.

In some embodiments, the system 101 may extract the number of lanes feature (also referred as feature F7) based on the received road object observation, the sensor data associated with the road 309, and the map data of the database 105a. Hereinafter, the ‘number of lanes feature’ and the ‘feature F7’ may be interchangeably used to mean the same. In various embodiments, the system 101 may determine, using the sensor data associated with the road 309, a number of lanes on the road 309 on which the vehicle 301 is travelling; determine, using the database 105a, a number of lanes on the road 309 for the given timestamp and the location of the road object 303; and compute a difference between the number of lanes determined using the database 105a and number of lanes determined using the sensor data, for extracting the number of lanes feature. In some example embodiments, the sensor data associated with the road 309 may comprise the number of lanes on the road 309. According to some embodiments, the number of lanes determined using the sensor data being less than the number of lanes determined using the map database 105a may indicate that the road object 303 is in the road work zone 307.

In some embodiments, the system 101 may extract the road work sign recognition event feature (also referred as feature F8) based on the received road object observation and the map data of the database 105a. Hereinafter, the ‘road work sign recognition event feature’ and the ‘feature F8’ may be interchangeably used to mean the same. In various embodiments, the system 101 may determine, using the database 105a, a closest road work sign (for instance, the road work sign 305) for the given timestamp and the given location of the road object 303; and determine an on-route distance between the closest road work sign and the road object 303 for extracting the road work sign recognition event feature. According to some embodiments, the on-route distance between the closest road work sign and the road object 303 being less than a pre-defined on-route distance of say two hundred and fifty (250) meter may indicate that the road object 303 is in the road work zone 307.

In some embodiments, the system 101 may extract the lane chicane feature (also referred as feature F9) based on the received speed sign observation, the map data of the database 105a, and the sensor data associated with the road 309. Hereinafter, the ‘lane chicane feature’ and the ‘feature F9’ may be interchangeably used to mean the same. In various embodiments, the system 101 may determine, using the sensor data associated with the road 309, a geometry of vehicle traces of the vehicle 301 on the road 309 for the given location of the road object 303; determine, using the database 105a, one or more lanes of the road 309 for the given timestamp and the given location of the road object 303; and compare (for instance, map-match) the determined geometry of vehicle traces to the one or more lanes of the road 309, for extracting the lane chicane feature. In some example embodiments, the extracted lane chicane feature may be a Boolean value. For instance, the Boolean value may be one, when the geometry of vehicle traces crosses the lanes of the road 309 and the Boolean value may be zero, when the geometry of vehicle traces does not crosses the lanes of the road 309. According to some embodiments, the geometry of vehicle traces being consistently crossing the predefined lanes of the road 309 may indicate that the road object 303 is in the road work zone 307.

In this way, the system 101 may extract the at least feature associated with the road object 303, the road 309, or the surrounding thereof. However, the at least one feature may not limited to the fore-mentioned features (i.e. features F1 to F9). Indeed, the system 101 may extract some additional features that fall within the scope of the invention. Further, the extracted at least one feature may further be processed to predict whether the road object 303 in the road work zone 307 or not.

In various embodiments, the system 101 may be configured to predict, using the trained machine learning model 201a-0, the presence data of the road work zone 307 associated with the road object 303, based on the extracted at least one feature. In some example embodiments, the system 101 may input the extracted at least one feature into the trained machine learning model 201a-0 to predict the presence data of the road work zone 307 associated with the road object 303. In other words, the execution module 201b of the system 101 may be configured to execute the trained machine learning model 201a-0 for the extracted at least one feature to predict the presence data of the road work zone 307 associated with the road object 303. In various embodiments, the machine learning model 201a-0 may be a supervised machine learning model. The machine leaning model 201a-0 may include random forest algorithm, a decision tree algorithm, a neural network (NN) algorithm and the like. In various embodiments, the machine learning model 201a-0 may be trained based on a training data set. In some example embodiments, the training module 201a-1 of the system 101 may be configured to train the machine learning model 201a-0 on the training data set. The training data set may comprise a combination of at least one training feature for each of a plurality of road object observations and ground truth label data for each of the plurality of road object observations. In various embodiments, the ground truth label data may comprise at least one of a road zone data (for instance, a road work zone data) and a non-road zone data (for instance, a non-road work zone data) for each of the plurality of road object observations. As used herein, the plurality of road object observations may correspond to road object observations (for instance, the speed sign observations) associated with the plurality of road objects (for instance, the plurality of speed signs). As used herein, the at least one training feature for each of the plurality of road object observations may correspond to the at least one of the fore-mentioned features (i.e. the features F1 to F9) for each of the plurality of road object observations. Further, the training phase of the machine learning model 201a-0 is explained in the detailed description of FIG. 4A-4B.

Once, the execution module 201b of the system 101 executes the trained machine learning model 201a-0 for the extracted at least one feature, the trained machine learning model 201a-0 may output a presence indicator value. In various embodiments, the presence indicator value may comprise at least one of a road zone indication (for instance, a road work zone indication) and a non-road zone indication (for instance, a non-road work zone indication). In some embodiments, the presence indicator value may be a Boolean output. For instance, the Boolean value of one may indicate a presence of the road work zone 307 and the Boolean value of zero may indicate an absence of the road work zone 307.

In some embodiments, the system 101 may determine a confidence value for the prediction. In other words, the system 101 may determine the confidence value for the predicted presence data of the road zone 307. For instance, the system 101 may determine a confidence score for the presence indicator value and/or for the Boolean value. In some embodiments, the system 101 may compare the determined confidence value with a threshold confidence value of say eighty (80) percent. In some embodiments, the system 101 may accept the prediction, if the determined confidence value is greater than the threshold confidence value. In some embodiments, the system 101 may transmit a request for a manual examination of the road object 303 (for instance, the speed limit sign), when the determined confidence value is less than the threshold confidence value. In some example embodiments, the manual examination of the road object may indicate to manually determine the presence of the road zone 307 associated with the road object 303. In some other example embodiments, the manual examination of the road object may indicate to determine, using probe vehicles, the presence of the road zone 307 associated with the road object 303.

Further, in some embodiments, the system 101 may configured to update the map data of the database 105a, when the determined confidence value is greater than the threshold confidence value. For instance, the system 101 may update the database 105a indicating that the road zone 307 is associated with the road object 307, when the determined confidence value is greater than the threshold confidence value. In some example embodiments, the system 101 may use the updated database 105a to mark the road object 303 (for instance, the speed limit sign) as a hazardous road object (for instance, a hazardous speed limit sign). In some other embodiments, the system 101 may be configured to generate, using the updated database 105a, one or more control signals for controlling the vehicle 301. For instance, the system 101 may generate, using the updated database 105a, one or more control signals to reduce speed of the vehicle 301 to permissible speed limit value of the road work zone 307. In an embodiment, the system 101 may generate, using the updated database 105a, one or more control signals to switch the autonomous vehicle 301 to a manual mode (where, the user of vehicle 301 drives the vehicle) from an automatic mode. In an another embodiment, the system 101 may generate, using the updated database 105a, a notification message to the user of the vehicle 301 for reducing the speed of the vehicle 301 to permissible speed limit value of the road work zone 307.

In this way, the system 101 may predict whether the road object 303 (for instance, the speed limit sign) is in the road work zone 307 or not and the system 101 may use the predicted results to provide the accurate navigation to the vehicle 303. Accordingly, the system 101 may avoid the unwanted situation such as road accidents, traffic congestions, and increased travel time, wastage of vehicle mile and the like by predicting the road zone 307 associated with the road object 303 before the vehicle 301 reaches the road zone 307. Further, the system 101 may provide one or more navigation functions based on the updated database 105a. Some non-limiting examples of the navigation functions may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like. Further, the training phase of the machine learning model 201a-0 is explained in the detailed description of FIGS. 4A-4B.

FIG. 4A illustrates a training data set 400a for training the machine learning model 201a-0, in accordance with an example embodiment. As exemplarily illustrated in FIG. 4A, the training data set 400a may comprise ‘n+1’ columns and ‘m’ rows (where the ‘n’ and ‘m’ may be a positive real number). In various embodiments, the ‘n’ columns (i.e. the columns from 401a to 401n) of the training data set 400a may correspond to the plurality of features F1-Fn which may comprise, third party traffic incident feed feature, the road object value feature, the lane marking color feature, the real time traffic feature, the traffic flow feature, the traffic pattern feature, the number of lanes feature, the road work sign recognition event feature, and the lane chicane feature respectively which have been described in detail in the description of FIG. 3 above. In some example embodiments, the ‘n’ columns may also include additional features that fall within the scope of the invention. In various embodiments, the column ‘n+1’ (i.e. the column 401n+1) may correspond to the ground truth label data. In various embodiments, the ground truth label data may be collected from probe vehicles or may be results of manual examinations on the road objects. In various embodiments, the ground truth label data may comprise at least one of the road zone (RZ) data and non-road zone (NRZ) data. In various embodiments, the ‘m’ rows (i.e. the rows from 403a to 403m) of the training data set 400a may correspond to the plurality of road object observations. For instance, the ‘m’ rows may indicate ‘m’ road object observation, where ‘m’ may be a positive integer. As used herein, the plurality of road object observations may correspond to road object observations (for instance, the speed sign observations) associated with the plurality of road objects (for instance, the plurality of speed signs).

In various embodiments, the system 101 may configured to obtain the plurality of road object observations from the probe vehicles. For instance, the system 101 may obtain ‘m’ finite road object observations. In various embodiments, the system 101 may obtain the plurality of road object observations from the probe vehicles. In various embodiments, the system 101 may extract at least one training feature for each of the plurality of road object observations. In some example embodiments, the system 101 may extract the at least training feature for each of the plurality of road object observations as explained in detailed description of FIG. 3. To that end, the training feature may be at least one of the third party traffic incident feed feature, the road object value feature, the lane marking color feature, the real time traffic feature, the traffic flow feature, the traffic pattern feature, the number of lanes feature, the road work sign recognition event feature, the lane chicane feature, or a combination thereof (i.e. at least one of feature F1 to Fn), for each of the plurality of road object observations.

In various embodiments, the system 101 may determine the ground truth label data for each of the plurality of road object observations. In some embodiments, the ground truth label data for each of the plurality of road object observations may be determined from the probe vehicles. In some other embodiments, the ground truth label data for each of the plurality of road object observations may be determined from the results of manual examinations of the plurality of road object observations. In various embodiments, the ground truth label data may comprise at least one of the road zone (RZ) data and non-road zone (NRZ) data. The road zone data may indicate the presence of the road zone 307. The non-road zone data may indicate the absence of road zone 307. In various embodiments, the system 101 may formulate the training data set 400a using the at least one training feature for each of the plurality of road object observations and the ground label data for each of the plurality of road object observations. To that end, elements of each row of the training data set 400a may comprise a combination of the at least one training feature for at least one road observation of the plurality of road object observations and the ground truth label data for at least one road observation of the plurality of road object observations collected from the probe vehicles. For instance, the row 403a may comprise the at least one extracted feature (i.e. at least one of columns 401a to 401n, where, the notation ‘x’ indicates the feature is unknown and the notation ‘✓’ indicates the feature is known) and the ground truth label data (i.e. the column 401n+1) for a road object observation of the plurality of road object observations.

In this way, the system 101 may formulate the training data set 400a for ‘m’ finite road object observations. Further, the training data set 400a may be used to train the machine learning model 201a-0 to predict whether the road object 303 (i.e. a road object observation made on a new lane and/or new road, where the probe vehicles have not travelled) is in the road zone 307 or not. The training of the machine learning model 201a-0 is explained in the detailed description of FIG. 4B.

FIG. 4B illustrates the training phase of the machine learning model 201a-0, in accordance with one or more embodiments. In various embodiments, the system 101 may be configured to train the machine learning model 405 to produce a trained machine learning model 407, based on the training data set 400a. For instance, the machine learning model 405 may be trained on the training data set 400a to produce the trained machine learning model 407. As illustrated in the FIG. 4A, the training data set 400a may comprise the combination of at least the extracted at least one training feature and the ground truth label data for each of the plurality of road object observations. In some embodiments, the machine learning model 405 may be the machine learning model 201a-0. To that end, the machine learning model 405 may comprise the classification algorithm. According to some embodiments, the classification algorithm may include at least one of a random forest algorithm, a decision tree algorithm, a neural network (NN) algorithm, and the like. In various embodiments, the machine learning model 405 may be the supervised machine learning model. Additionally, the machine learning model 405 may comprise one or more feature ranking algorithms such as predictive power algorithm, information gain algorithm, chi square algorithm, and the like for ranking the features. In some example embodiments, the rankings of the feature may vary based on the location of the road object.

In various embodiments, the trained machine learning model 407 may be executed by the system (for instance, the execution module 201b) to accurately predict whether the road object observation made on the new lane and/or the new road (for instance, the road 309) is in the road zone 307 or not. As used herein, the new lane and/or new road may correspond to a lane and/or a road on which the probe vehicles have not travelled for collecting the road object observations. In some embodiments, the system 101 may use ten (10)-fold cross validation technique to separate training data (for instance, the training data set 400a) from testing data. As used herein, the testing data may correspond to one or more road object observations made on the one or more new lanes and/or the one or more new roads. In some example embodiments, the system 101 may use a seventy is to thirty (i.e. 70:30) ratio to train and test the machine learning model 405, where the seventy percent correspond to the training data (i.e. the training data set 400a) and the thirty percent correspond to the testing data.

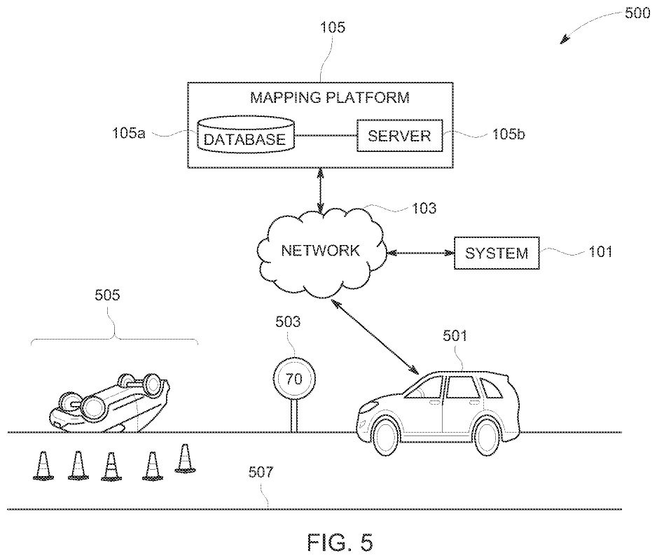

In this way, the machine learning model 405 may be trained on the training data set 400a to accurately predict whether the road object 303 (i.e. the road object observation made on the new lane or the new road) is in the road zone 307 or not. In some embodiments, the system 101 may be used to accurately predict whether the road object 303 is in the road zone 307 or not, when the road zone 307 is the accident zone, as will be explained in the detailed description of FIG. 5.

FIG. 5 illustrates a schematic diagram 500 of an exemplary working environment of the system 101 exemplarily illustrated in FIG. 2, in accordance with one or more example embodiments. As illustrated in FIG. 5, the schematic diagram 500 may include the system 101, the network 103, the mapping platform 105, a vehicle 501, a speed sign 503, an accident zone 505, and a road 507. Additionally, the schematic diagram 500 may include a temporary accident sign indication on the road 507. The road 507 may be the new road, where the probe vehicles have not travelled for collecting the road object observations. The vehicle 501 may be an autonomous vehicle, a semiautonomous vehicle, or a manual vehicle. In various embodiments, the speed sign 503 may be a static speed sign, a mechanical variable speed sign, a variable speed sign, or a conditional static speed sign. As used herein, the speed sign 503 may correspond to the road object. Here, the speed sign 503 is considered for illustration purpose. In various embodiments, the road object may comprise any other of a speed limit sign, a directional guidance sign, a signboard indicating route deviation, a signboard indicating some ongoing work along the road, a road divider, a construction object, or a road flare and the like.

In various embodiments, the system 101 may be configured to receive, from the sensors of the vehicle 501, at least one road object observation (i.e. the speed sign observation) associated with the speed sign 503. For instance, the system 101 may receive a location and/or a speed limit value of the speed sign 503 from the sensors as the speed sign observation. Additionally, the speed sign observation may comprise the timestamp indicating a time instance at which the speed sign observation was made.

In various embodiments, the system 101 may be configured to extract at least one feature associated with the speed sign 503, the road 509, or the surrounding thereof based on the received at least one speed sign observation. For instance, the system 101 may extract the at least one feature associated with the speed sign 503, the road 507, or the surrounding thereof as explained in the detailed description of FIG. 3. To that end, the extracted at least one feature may be at least one of at least one of the third party traffic incident feed feature, the road object value feature, the lane marking color feature, the real time traffic feature, the traffic flow feature, the traffic pattern feature, the number of lanes feature, the road work sign recognition event feature, the lane chicane feature, or a combination thereof. According to some embodiments, in accident sites such as the accident zone 505, special lane marking (for instance, a lane marking indicating a deviation from the accident zone 505) may be provided on the road 507. To that end, the system may extract a lane marking feature (including the special lane marking) along the lane marking color feature.

In various embodiments, the system 101 may be configured to predict, using the trained machine learning model 407, the presence data of the accident zone 505 associated with the speed sign 503, based on the extracted at least one feature. For instance, the system 101 may input the extracted at least one feature into the trained machine learning model 407 to make the predictions. Further, the system 101 may be configured update the dataset 105 and/or the local map cache of the vehicle 501 for accurately providing the navigation instructions based on the predictions. Accordingly, the system 101 may predict the up-coming accident zone 505 on the road 507 and provides the accurate navigation instructions to avoid the unwanted situations such as road accidents, traffic congestions, increased travel time, wastage of vehicle mile and the like.

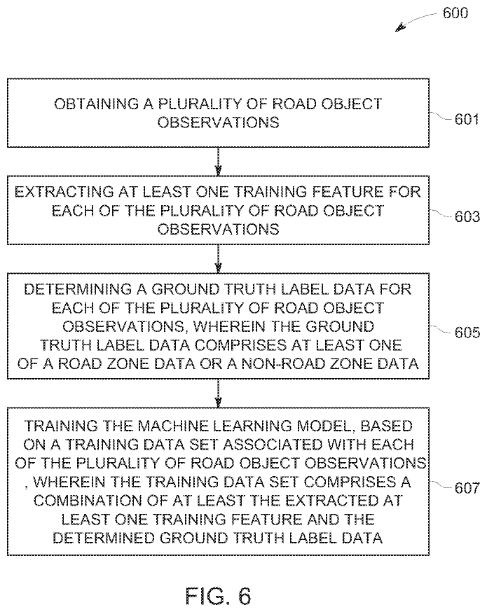

FIG. 6 illustrates a flowchart depicting a method 600 for training a machine learning model, in accordance with one or more example embodiments. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 203 of the system 101, employing an embodiment of the present invention and executed by the processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Starting at block 601, the method 600 may include obtaining a plurality of road object observations. In some embodiments, the plurality of road object observations may correspond to road object observations (for instance, the speed sign observations) associated with the plurality of road objects (for instance, the plurality of speed signs). In other words, the plurality of road object observations may be road object observations associated with different locations of road objects. In some other embodiments, the plurality of road object observations may be road observations associated with one location of road object at different instance of time. In various embodiments, the plurality of road object observations may be obtained from probe vehicles. Each of the plurality of road object observations may comprise the location associated with the road object and/or the road object value associated with the road object.

At block 603, the method 600 may include extracting at least one feature for each of the plurality of road object observations. For instance, the at least one training feature may be extracted as explained in the detail description of FIG. 3 for each of the plurality of road object observations. To that end, the extracted at least one training feature may be at least one of the third party traffic incident feed feature, the road object value feature, the lane marking color feature, the real time traffic feature, the traffic flow feature, the traffic pattern feature, the number of lanes feature, the road work sign recognition event feature, the lane chicane feature, or a combination thereof (i.e. at least one of feature F1 to F9), for each of the plurality of road object observations.

At block 605, the method 600 may include determining the ground truth label data for each of the plurality of road object observations. In some embodiments, the ground truth label data for each of the plurality of road object observations may be determined from the probe vehicles. In some other embodiments, the ground truth label data for each of the plurality of road object observations may be determined from the results of manual examinations of the plurality of road object observations. In various embodiments, the ground truth label data may comprise at least one of the road zone (RZ) data and non-road zone (NRZ) data. The road zone data may indicate the presence of the road zone. The non-road zone data may indicate the absence of road zone.

At block 607, the method 600 may include training the machine learning model 201a-0, based on the training data set associated with each of the plurality of road object observations. For instance, the machine learning model 201a-0 may be trained on the training data set 400a to produce the trained machine learning model 201a-0. The training data set may comprise a combination of at least the extracted at least one feature and the determined ground truth label data for each of the plurality of road object observations. In some embodiments, the machine learning model 201a-0 may comprise the classification algorithm. According to some embodiments, the classification algorithm may include at least one of a random forest algorithm, a decision tree algorithm, a neural network (NN) algorithm, and the like. In various embodiments, the machine learning model 201a-0 may be the supervised machine learning model. Further, the trained machine learning module 201a-0 may be executed in the execution phase or in real-time to predict whether the road object 303 (i.e. the road object observation made on the new lane or the new road) is in the road zone 307 or not.

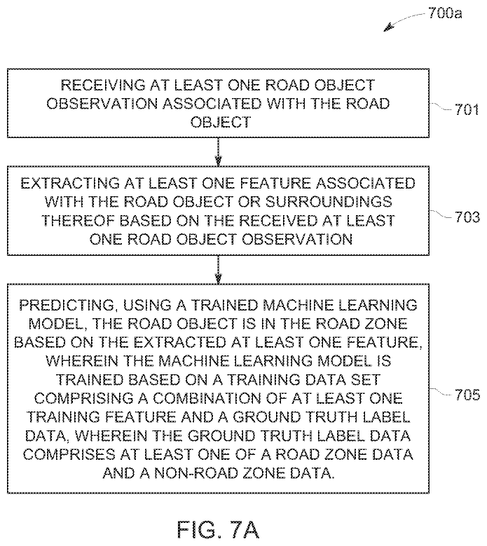

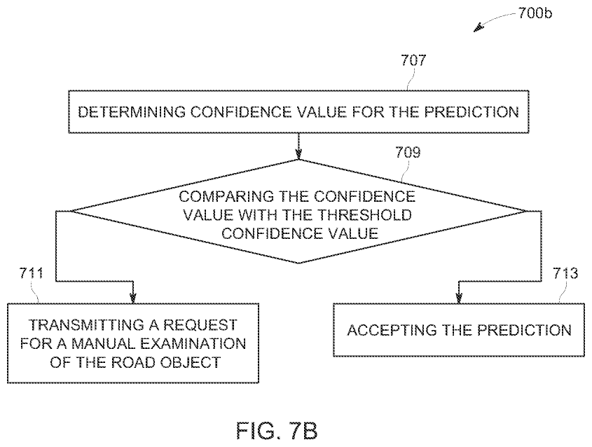

FIG. 7A illustrates a flowchart depicting a method 700a for predicting that the road object 303 is in the road zone 307 or not, in accordance with one or more example embodiments. It should be understood that a system for performing each block of the method 700a may comprise a processor (e.g. the processor 201) configured to perform some or each of the blocks (701-705) described above. The processor may, for example, be configured to perform the blocks (701-705) by performing hardware implemented logical functions, executing stored instructions, or executing algorithms for performing each of the blocks. Alternatively, the system may comprise means for performing each of the blocks described below. In this regard, according to an example embodiment, examples of means for performing blocks 701-705 may comprise, for example, the processor 201 and/or a device or circuit for executing instructions or executing an algorithm for processing information as described above.

Starting at block 701, the method 700a may include receiving at least one road object observation associated with the road object 303. For instance, the at least one road object observation may be received from the sensors of the vehicle 301. In various embodiments, the at least one road observation may be received from the vehicle 301, when the vehicle is travelling on the new lane or the new road. As used herein, the new lane or the new road may be a lane or a road on which the probe vehicles have not travelled to collect the road object observations. In various embodiments, the road object observation may comprise the location associated with the road object 303 and the road object value associated with the road object 303. Further, in some embodiments, the road object observation may comprise a timestamp indicating a time instance at which the road object observation was made. The road object 303 may comprise the speed limit sign, the directional guidance sign, the signboard indicating route deviation, the signboard indicating some ongoing work along the road (for instance, the road work sign 305), the road divider, the construction object, the road flare and the like.

At block 703, the method 700a may include extracting at least one feature associated with the road object 303 or surroundings thereof based on the received at least one road object observation. For instance, the at least one feature associated with the road object 303 or surroundings thereof may be extracted as explained in the detailed description of FIG. 3. In some example embodiments, the at least one feature may be extracted in questions of the timestamp (i.e. the time instance at which the speed sign observation was made) for the received road object observation. To that end, the at least one feature may be a spatiotemporal feature. That is to say, the at least one feature may have different values based on variation in time or geographic constraints. For example, for different times of day, and for different regions or countries or cities, the feature may have different values and different relevance. In some embodiments, a relevancy score may be associated with the feature, to provide a weightage to the feature when using a combination of such features, as will be described in various embodiments disclosed herein. In various embodiments, the at least one feature may comprise at least one of the third party traffic incident feed feature, the road object value feature, the lane marking color feature, the real time traffic feature, the traffic flow feature, the traffic pattern feature, the number of lanes feature, the road work sign recognition event feature, the lane chicane feature, or a combination thereof.

At block 705, the method 700a may include predicting, using the trained machine learning model 201a-0, that the road object 303 is in the road zone 307 or not based on the extracted at least one feature. For instance, the extracted at least one feature may be inputted into the trained machine learning model 201a-0 for predicting whether the road object 303 is located within a threshold distance around the road zone 307. The threshold distance may be a configurable distance. In some example embodiments, when the road object 303 is located within the threshold distance around the road zone 307, the road object 303 may not be located within an actual boundary defining the road zone 307 but in a nearby around the road zone 307. For example, if the road zone 307 is a construction zone, the boundary of the road zone 307 may be defined by placing some traffic cones around an actual construction location. Further, the road object 303 may be a speed limit sign, which may be placed in the nearby area around the boundary defined by the traffic cones. This nearby area may be identified based on the threshold distance, such that when the vehicle 301 reaches a location where its distance from the boundary of the road zone 307 lies within this threshold distance, the trained machine learning model 201a-0 may be configured to predict that the road object 303 is in the road zone 307.

In some embodiments, the road object 303 may be within actual limits of extensibility of the road zone 307 itself. The limits of extensibility of the road zone 307 may be defined in terms of a distance range starting from a start location and ending at an ending location. For example, when the road zone 307 is the construction zone as discussed above, the start location may be location of the first traffic cone and the ending location may be a location of the last traffic cone defining the boundary of the construction zone. As may be evident to one skilled in the art, that the starting location and the ending location may be configurable parameters, and the distance between the starting location and the ending location may define the distance range which is also a configurable value. In some examples, the distance range may be sufficient to cover a length of distance over which the vehicle 301 may be able to decelerate and navigate safely through the road zone 307. When the vehicle 301 reaches within this limit of extensibility of the road zone 307, the trained machine learning model 201a-0 may be configured to predict that the road object 303 is in the road zone 307. Thus, the road zone 307 may be defined in any of the manners discussed above without limiting the scope of the present invention, and irrespective of the manner in which the road zone 307 is defined, the trained machine learning model 201a-0 may be executed for the extracted at least one feature to predict that the road object 303 is in the road zone 307 or not. In various embodiments, the road zone 307 may comprise the accident zone, the road work zone, the vehicle-brake-down zone, and the like. In various embodiments, the machine learning model 201a-0 may be trained based on the training data set 400a. The training data set 400a may comprise the combination of the at least one training feature for each of the plurality of road object observations and ground truth label data for each of the plurality of road object observations. In various embodiments, the ground truth label data may comprise at least one of the road zone data and the non-road zone data for each of the plurality of road object observations. In some embodiments, the block 705 may further include outputting the presence indicator value from the trained machine learning model 201a-0. In various embodiments, the presence indicator value comprises at least one of a road zone indication and a non-road zone indication.

In some example embodiments, the method 700a may further include various other blocks not shown in FIG. 7A. Further, the various other blocks not shown in FIG. 7A are shown and explained in the detailed description of FIG. 7B.

FIG. 7B illustrates a flowchart depicting a method 700b for additional blocks of the method 700a to predict that the road object 303 is in the road zone 307 or not, in accordance with one or more example embodiments. Starting at block 707, the method 700b may include determining the confidence value for the prediction. For instance, the system 101 may determine the confidence score for the presence indicator value. At block 709, the method 700b may include comparing the confidence value with the threshold confidence value. In some example embodiments, the threshold confidence value may be eighty (80) percent. However, the threshold confidence value may be a configurable confidence value. At block 711, the method 700b may include transmitting the request for the manual examination of the road object 303, in response to determining that the determined confidence value being less than the threshold confidence value. At block 713, the method 700b may include accepting the prediction, in response to determining that the determined confidence value being greater than the threshold confidence value. In some example embodiments, the block 713 may further include updating the map data of the database 105a based on the accepted predictions. Further, the updated database 105a may be used to perform one or more navigation functions. Some non-limiting examples of the navigation functions may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like. Accordingly, the unwanted situation such as road accidents, traffic congestions, increased travel time, wastage of vehicle mile and the like may be avoided.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A method for predicting that a road object is in a road zone or not, the method comprising:
receiving at least one road object observation associated with the road object;
extracting at least one feature associated with the road object or surroundings thereof based on the received at least one road object observation; and
predicting, using a trained machine learning model, that the road object is in the road zone or not based on the extracted at least one feature, wherein the machine learning model is trained based on a training data set comprising a combination of at least one training feature and a ground truth label data, wherein the ground truth label data comprises at least one of a road zone data and a non-road zone data.

2. The method of claim 1, wherein predicting that the road object is in the road zone or not further comprises outputting a presence indicator value from the trained machine learning model, wherein the presence indicator value comprises at least one of a road zone indication and a non-road zone indication.

3. The method of claim 1, wherein the at least one feature comprises at least one of a third party traffic incident feed feature, a road object value feature, a lane marking color feature, a real time traffic feature, a traffic flow feature, a traffic pattern feature, a number of lanes feature, a road work sign recognition event feature, a lane chicane feature, or a combination thereof.

4. The method of claim 1, further comprising updating a map database based on the prediction.

5. The method of claim 1, wherein the at least one feature is a spatiotemporal feature.

6. The method of claim 1, wherein the road zone comprises at least one of an accident zone and a road work zone.

7. The method of claim 1, wherein the road object comprises a speed limit sign, a construction work sign, an accident site object, a road divider, a construction object, an accident site sign, or a road flare.

8. The method of claim 1, wherein the at least one road object observation comprises at least one of a location associated with the road object, a timestamp associated with the road object, or a combination thereof.

9. The method of claim 1, further comprising:
determining a confidence value for the prediction;
comparing the confidence value with a threshold confidence value; and
accepting the prediction, in response to determining that the confidence value is greater than the threshold confidence value.

10. The method of claim 1, further comprising:
determining a confidence value for the prediction;
comparing the confidence value with a threshold confidence value; and
transmitting a request for a manual examination of the road object, in response to determining that the confidence value is lesser than the threshold confidence value.

11. A system for predicting presence data of a road zone associated with a road object, the system comprising:
a memory configured to store computer-executable instructions; and
one or more processors configured to execute the instructions to:
receive at least one road object observation associated with the road object;
extract at least one feature associated with the road object or a road thereof, based on the received at least one road object observation; and
predict, using a trained machine learning model, presence data of the road zone associated with the road object based on the extracted at least one feature, wherein the machine learning model is trained based on a training data set comprising a combination of at least one training feature and a ground truth label data, wherein the ground truth label data comprises at least one of a road zone data or a non-road zone data.

12. The system of claim 11, wherein to predict the presence data of the road zone associated with the road object, the one or more processors are further configured to execute the instructions to output a presence indicator value from the trained machine learning model, wherein the presence indicator value comprises at least one of a road zone indication and a non-road zone indication.

13. The system of claim 11, wherein the at least one feature comprises at least one of a third party traffic incident feed feature, a road object value feature, a lane marking color feature, a real time traffic feature, a traffic flow feature, a traffic pattern feature, a number of lanes feature, a road work sign recognition event feature, a lane chicane feature, or a combination thereof.

14. The system of claim 11, wherein the one or more processors are further configured to execute the instructions to update a map database based on the prediction.

15. The system of claim 11, wherein the at least one feature is a spatiotemporal feature.

16. The system of claim 11, wherein the road zone comprises one or more of an accident zone and a road work zone.

17. The system of claim 11, wherein the road object comprises a speed limit sign, a construction work sign, an accident site object, a road divider, a construction object, an accident site sign, or a road flare.

18. The system of claim 11, wherein the one or more processors are further configured to execute the instructions to:
determine a confidence value for the predicted presence data of the road zone;
compare the confidence value with a threshold confidence value; and
accept the predicted presence data of the road zone, in response to determining that the confidence value is greater than the threshold confidence value.

19. The system of claim 11, wherein the one or more processors are further configured to execute the instructions to:
determine a confidence value for the predicted presence data of the road zone;
compare the confidence value with a threshold confidence value; and
transmit a request for a manual examination of the road object, in response to determining that the confidence value is lesser than the threshold confidence value.

20. A computer program product comprising a non-transitory computer readable medium having stored thereon computer executable instruction which when executed by one or more processors, cause the one or more processors to carry out operations for training a machine learning model, the operations comprising:
obtaining a plurality of road object observations;
extracting at least one training feature for each of the plurality of road object observations;
determining a ground truth label data for each of the plurality of road object observations, wherein the ground truth label data comprises at least one of a road zone data or a non-road zone data; and
training the machine learning model, based on a training data set associated with each of the plurality of road object observations, wherein the training data set comprises a combination of at least the extracted at least one training feature and the determined ground truth label data.
